(19) United States
(12) Patent Application Publication
(10) Pub. No.: US 2010/0066847 A1
(43) Pub. Date: Mar. 18, 2010

(54) Imaging apparatus and program

(75) Inventors: Maki Suzuki, Tokyo (JP); Takuya Shirahata, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/312,944

(22) PCT Filed: Feb. 5, 2008
(86) PCT No.: PCT/JP2008/000145

§ 371 Date: Jun. 1, 2009

(30) Foreign Application Priority Data
Feb. 22, 2007 (JP) 2007-042047

(51) Int. Cl. H04N 5/228

(52) U.S. Cl. 348/222.1; 348/E05.031

(57) ABSTRACT

An imaging apparatus includes an imaging section, a memory, and a control section. The imaging section captures an image of an object and generates data of the image. The memory records pieces of feature information respectively corresponding to each of a plurality of registered objects to be recognized as recognition targets. The control section recognizes the registered objects included in the image based on the feature information. Further, the control section executes predetermined processing when two or more of specified objects which are specified among the registered objects are included in the image.

### TECHNICAL FIELD

The present application relates to an imaging apparatus provided with a recognizing function of an object.

### BACKGROUND ART

Conventionally, there has been proposed a various types of cameras having a recognizing function of an object in a shooting screen. For example, Patent Document 1 discloses a configuration of a camera which automatically performs release when a face of a person is detected in a shooting screen.

Patent Document 1: Japanese Unexamined Patent Application Publication No. 2003-92700

### DISCLOSURE OF THE INVENTION

### Problems to be Solved by the Invention

However, a camera of the conventional art performs a shooting and the like when it can recognize a single object. Accordingly, when a plurality of main objects are to be simultaneously shot, it was not always possible to shoot scenes desired by a user, and thus there is room for improvement regarding the above point.

The present application is to solve the aforementioned problem of the conventional art. A proposition of the present application is to provide means with which a convenience to a user is further enhanced in a scene where a plurality of main objects are simultaneously shot.

### Means for Solving the Problems

An imaging apparatus according to a first embodiment includes an imaging section, a memory, and a control section. The imaging section captures an image of an object and generates data of the image. The memory records pieces of feature information respectively corresponding to each of a plurality of the registered objects to be recognized as recognition targets. The control section recognizes the registered objects included in the image based on the feature information. Further, the control section executes predetermined processing when two or more of specified objects which are specified among the registered objects are included in the image.

In a second embodiment according to the first embodiment, the control section executes at least one of processing among a first processing instructing the imaging section to capture a recording image, a second processing outputting a notification to a user, and a third processing generating metadata regarding the specified objects.

In a third embodiment according to the second embodiment, the control section instructs to capture the recording image when at least one of the specified objects is in a predetermined position in the image at the time of executing the first processing.

In a fourth embodiment according to the first embodiment, the control section generates the feature information from data of a first recording image captured by the imaging section, data of a second recording image read from the outside, or data of a through image captured by the imaging section when unrecorded.

In a fifth embodiment according to the first embodiment, the imaging apparatus further includes a focus detecting section, a focus detecting area selecting section, an operation section, and a tracking setting section. The focus detecting section detects a focus state in a focus detecting area set in a shooting screen. The focus detecting area selecting section continuously selects a corresponding position of the specified objects in the shooting screen as the focus detecting area based on a result of the recognition. The operation section accepts an operation from a user. The tracking setting section changes an order of precedence of the specified objects, in accordance with an operation of the operation section, for selecting the focus detecting area in a scene where a plurality of the specified objects exist.

In a sixth embodiment according to the first embodiment, the imaging apparatus further includes an operation section that accepts an operation from a user. Further, the control section sets the specified objects among the registered objects based on an operation of the operation section.

A program according to a seventh embodiment is applied to a computer configured to be able to communicate with an imaging apparatus. The aforementioned imaging apparatus includes an imaging section that captures an image of an object and generates data of the image, a memory capable of recording, pieces of feature information respectively corresponding to each of a plurality of registered objects to be recognized as recognition targets, a camera control section that recognizes the registered objects included in the image based on the feature information and automatically executes a capture of recording image when two or more specified objects which are specified among the registered objects are included in the image, and a camera communication section. Further, the computer includes a communication section that transmits data to the imaging apparatus, a recording section that accumulates the pieces of feature information corresponding to the plurality of the registered objects, and a calculation processing section.

Further, the aforementioned program causes the calculation processing section of the computer to execute the following steps. In a first step, an input from a user to select two or more of the specified objects among the registered objects, and the pieces of feature information respectively corresponding to each of two or more of the specified objects is extracted from the recording section. Further, in a second step, the feature information extracted in the first step is transmitted to the imaging apparatus.

### EFFECTS OF THE INVENTION

In the present application, when two or more of the specified objects which are specified among the registered objects are included in the image, the control section executes the predetermined processing, which provides an improved convenience to a user who tries to simultaneously shoot a plurality of main objects.

### BRIEF DESCRIPTION OF THE DRAWINGS

FIG. 1 is a block diagram explaining a configuration of an electronic camera of a first embodiment.

FIG. 2 is a schematic view showing a display state of a monitor when an object is recognized.

FIG. 3 is a view showing an example of a selection screen for specified objects.

FIG. 4 is a view showing a detail setting screen which can be transited from the screen of FIG. 3.

FIG. 5 is a view showing a screen on which a range of a position in which specified objects fall is specified.

FIG. 6 is a view showing a screen on which positions of respective specified objects at the time of automatic shooting are specified.

FIG. 7 is a flow chart showing a shooting operation in an object recognition mode in the first embodiment.

FIG. 8 is a view showing a change screen for an order of precedence of AF at the time of activating the object recognition mode.

FIG. 9 is a view showing an example of a state where a setting of recognition state of the specified objects and a through image match.

FIG. 10 is a flow chart showing a shooting operation in an object recognition mode in a second embodiment.

FIG. 11 is a view schematically showing a configuration of an electronic camera system of a third embodiment.

FIG. 12 is a flow chart explaining an operation of a computer in the third embodiment.

### BEST MODE FOR CARRYING OUT THE INVENTION

### Explanation of First Embodiment

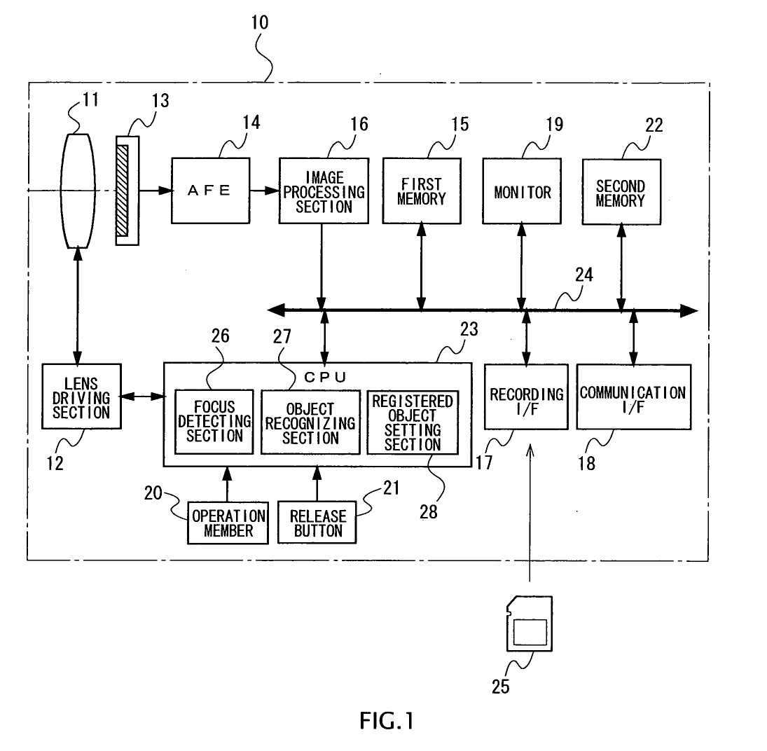

FIG. 1 is a block diagram explaining a configuration of an electronic camera 10 of a first embodiment. The electronic camera 10 of the present embodiment is provided with an object recognizing function.

The electronic camera 10 has an imaging optical system 11 and a lens driving section 12, an image sensor 13, an AFE 14, a first memory 15, an image processing section 16, a recording I/F 17, a communication I/F 18, a monitor 19, an operation member 20, a release button 21, a second memory 22, a CPU 23, and a bus 24. Here, the first memory 15, the image processing section 16, the recording I/F 17, the communication I/F 18, the monitor 19, the second memory 22, and the CPU 23 are coupled with each other via the bus 24. Further, the lens driving section 12, the operation member 20, and the release button 21 are each coupled to the CPU 23.

The imaging optical system 11 is formed of a plurality of lens groups including a zoom lens and a focusing lens. A lens position of the focusing lens of the imaging optical system 11 is adjusted in the optical axis direction by the lens driving section 12. Note that for simplicity, the imaging optical system 11 is illustrated as one piece of lens in FIG. 1.

The image sensor 13 is arranged on the image space side of the imaging optical system 11. On a light-receiving surface of the image sensor 13, light-receiving elements are arranged two-dimensionally. The image sensor 13 generates an analog image signal by photoelectric convert an object image generated by optical flux passing through the imaging optical system 11. An output of this image sensor 13 is coupled to the AFE 14.

Here, in a shooting mode as one of the operation mode of the electronic camera 10, the image sensor 13 captures a recording image (main image) in response to a full-press operation of the release button 21. Further, in the shooting mode, the image sensor 13 captures a through image by thinning-out reading at every predetermined interval also at the time of shooting standby. Note that the data of the through image is used for an image display on the monitor 19, various calculation processing by the CPU 23, and so on.

The AFE 14 is an analog front-end circuit which performs analog signal processing on an output of the image sensor 13. This AFE 14 performs correlated double sampling, gain adjustment of an image signal, A/D conversion of an image signal, and the like. Note that an output of the AFE 14 is coupled to the image processing section 16.

The first memory 15 temporarily stores data of an image before and after image processing by the image processing section 16.

The image processing section 16 performs various types of image processing (color interpolation processing, gradation conversion processing, edge enhancement processing, white balance adjustment, and so on) on a digital image signal for one frame. Note that the image processing section 16 also executes resolution conversion processing on the main image, and compression processing or expansion processing on data of the main image.

In the recording I/F 17, a connector for coupling a recording medium 25 is formed. Then the recording I/F 17 executes writing/reading of data to/from the recording medium 25 coupled to the connector. The aforementioned recording medium 25 is formed by a hard disk, a memory card including a semiconductor memory, or the like. Note that FIG. 1 shows the memory card as an example of the recording medium 25.

The communication I/F 18 controls transmission/reception of data to/from an external device in compliance with the specification of well-known communication standard via wire or wireless.

The monitor 19 displays various images according to an instruction by the CPU 23. Note that the configuration of the monitor 19 of the present embodiment may be either an electronic finder having an eyepiece part, or a liquid crystal display panel provided on the rear face of the camera case.

On the aforementioned monitor 19, the through image is movie-displayed by the control of the CPU 23 at the time of shooting standby in the shooting mode. At this time, it is also possible that the CPU 23 superimposes a display of various pieces of information necessary for shooting on the through image on the monitor 19 with the use of an on-screen function. In addition, the CPU 23 can also display a menu screen on the monitor 19 on which inputs of various setting items can be made.

The operation member 20 is formed of, for example, a command dial, a cross-shaped cursor key, a decision button, a registration button and the like. Further, the operation member 20 accepts various types of inputs of the electronic camera 10 from the user. For instance, the operation member 20 is used for an input operation on the aforementioned menu screen, a switching operation of the operation mode of the electronic camera 10 and the like.

The release button 21 accepts an instruction input of a start of operation of auto-focus (AF) before shooting by a half-pressing operation and an instruction input of a start of imaging operation by a full-pressing operation from the user.

The second memory 22 records feature information on the registered object to be a target for the object recognition (data for recognizing the registered object from the through image). The second memory 22 is a non-volatile storage medium such as a flash memory. In the electronic camera 10 of the present embodiment, it is possible to register all things including people, animals, buildings, vehicles, and the like as the registered objects.

Here, the feature information in the present embodiment is configured by data of an image formed by capturing an image of registered object. If the image of the registered object itself is set to be the feature information as in the above case, a size of the registered object or the like may be previously normalized at the time of registration. Note that when a person is the registered object, by previously registering feature information regarding a face of each registered object in the second memory 22, it also becomes possible to perform authentication of the person being the registered object in the electronic camera 10.

Further, the feature information recorded in the second memory 22 is compiled into database by being corresponded to each of the registered objects. Specifically, a plurality of pieces of feature information regarding the same registered object can be grouped and registered in the second memory 22. For instance, in order to enhance an accuracy of object recognition, it is also possible to register a plurality of pieces of feature information regarding one registered object in which a shooting angle, a shooting direction or the like is different (for example, regarding a face of a person, images with different angles). Note that it is also possible to register, in the second memory 22, attribute information on the specified object (text data regarding a name, an address or the like of the object), a thumbnail image and so on for each of the registered objects.

The CPU 23 is a processor that comprehensively controls the operation of the electronic camera 10. As an example, the CPU 23 controls operations of respective sections of the electronic camera 10 in the aforementioned shooting mode. Further, the CPU 23 generates metadata to be recorded in a header region of an image file in compliance with an Exif (Exchangeable image file format for digital still cameras) standard.

Here, the CPU 23 of the present embodiment functions as a focus detecting section 26, an object recognizing section 27, and a registered object setting section 28 by an execution of a program stored in a not-shown ROM.

The focus detecting section 26 performs a well-known AF calculation by a contrast detection system based on the data of the through image. Further, the focus detecting section 26 detects a focus state of an object in a focus detecting area set in a shooting screen.

The object recognizing section 27 recognizes, in an object recognition mode being one of the shooting mode, a registered object from the through image based on the aforementioned feature information.

As an example, the object recognizing section 27 executes matching processing in which an object in the through image is analyzed based on the feature information (image of the registered object). Note that the object recognizing section 27 executes the matching processing by focusing attention on the commonness of patterns such as, for example, a brightness component, a color difference component, an edge component, and a contrast ratio of image.

Next, the object recognizing section 27 calculates, based on a result of the aforementioned matching processing, a degree of similarity of the object in the through image with respect to each of the registered objects. Subsequently, when the above-described degree of similarity takes a value equal to or larger than a threshold value, the object recognizing section 27 determines that the registered object exists in the through image.

Here, when there exist a plurality of objects in the same image, the object recognizing section 27 executes the aforementioned matching processing with respect to each of the objects. Further, when there exist a plurality of registered objects whose degree of similarity with respect to the same object in the through image takes a value equal to or larger than the threshold value, the object recognizing section 27 preferentially recognizes the registered object with the highest degree of similarity.

Note that the object recognizing section 27 in the object recognition mode can continuously select a corresponding position of the registered object in the shooting screen as the focus detecting area based on a result of the object recognition. Accordingly, the focus detecting section 26 can perform the AF by tracking the registered object in the object recognition mode.

The registered object setting section 28 executes various types of setting processing relating to the object recognition mode. For example, the registered object setting section 28 sets, in accordance with the user's operation, a specified object to be a target of the object recognition among the registered objects. Further, the registered object setting section 28 generates the feature information on the registered object from data of the image, and registers the registered object and the feature information in the second memory 22 in accordance with the user's operation. In addition, the registered object setting section 28 also executes a setting of operation of the electronic camera 10 when a plurality of specified objects are recognized, a setting of an order of precedence of the specified objects when performing the AF by tracking the object, and so on.

The operation of the electronic camera 10 of the first embodiment will be classified into a registration of feature information on objects, a setting of the object recognition mode and an operation of the electronic camera in the object recognition mode, and each of the above will be explained hereinbelow.

<Registration of Feature Information on Objects>

When a shooting is performed in the object recognition mode, the user has to previously record the feature information on the registered objects to be the recognition targets in the second memory 22. In the electronic camera 10 of the present embodiment, it is possible to set the registered objects using the following three main methods.

(1) Setting of Registered Objects Based on Recording Image of Still Image

In this case, the CPU 23 generates the feature information based on data of a still image captured by the electronic camera 10.

Firstly, the user makes the electronic camera 10 read data of a recording image in which an image of an object to be registered is captured. Concretely, the CPU 23 reads the data of the recording image and the like from a not-shown external device (for example, a server on the internet, a personal computer or the like) coupled via the communication I/F 18, or the recording medium 25 of the recording I/F 17. In general, the CPU 23 mainly reads data, from the recording medium 25, regarding the main image captured by the electronic camera 10. In like manner, data of a main image captured by another electronic camera is mainly read to the CPU 23 from the communication I/F 18.

Secondly, the CPU 23 reproduces and displays the aforementioned recording image on the monitor 19. The user selects the registered object from the reproduced image and indicates the registered object to the CPU 23 via the operation member 20. For example, the CPU 23 displays a rectangular frame for specifying the registered object on the monitor 19 to let the user manipulate the rectangular frame and input the registered object. Subsequently, the CPU 23 cuts a portion corresponding to the registered object out of the recording image to generate the feature information. Thereafter, the feature information is recorded in the second memory 22. Note that when newly generated feature information is registered, the user may newly register a group of registered object to record it in the second memory 22, or may record the information in the second memory 22 by corresponding it to the existing group of the registered object.

(2) Setting of Registered Object Based on Through Image

In this case, the CPU 23 generates the feature information based on the through image captured by the image sensor 13.

As an example, when the CPU 23 detects a press of the registration button of the operation member 20 while the through image is movie-displayed in the shooting mode, it displays the rectangular frame for specifying the registered object on a predetermined position of the through image on the monitor 19 (for instance, a center of the screen). Subsequently, when the release button 21 is pressed under the state where the registration button is kept pressed, the CPU 23 generates the feature information based on data of the through image by setting the object positioned inside the aforementioned rectangular frame as the registered object. Thereafter, the feature information is recorded in the second memory 22 similarly as in the aforementioned case of (1).

(3) Setting of Registered Object Based on Recording Image of Moving Image

In this case, the CPU 23 generates the feature information based on data of the moving image captured by the electronic camera 10.

As a first example, upon detecting a press of the registration button when a moving image file is reproduced, the CPU 23 displays the rectangular frame for specifying the registered object on the monitor 19. The CPU 23 moves the position of the rectangular frame in accordance with the user's operation of the cursor key and the like. Subsequently, when the decision button is pressed under the state where a desired object exactly falls in the rectangular frame, the CPU 23 generates the feature information by setting the object inside the rectangular frame as the registered object. At this time, the CPU 23 may generate the feature information from not only the frame when the decision button is pressed but also frames before and behind the frame. Note that the CPU 23 may change a display color of the frame on the monitor 19 when the decision button is pressed, to thereby indicate that the object is registered.

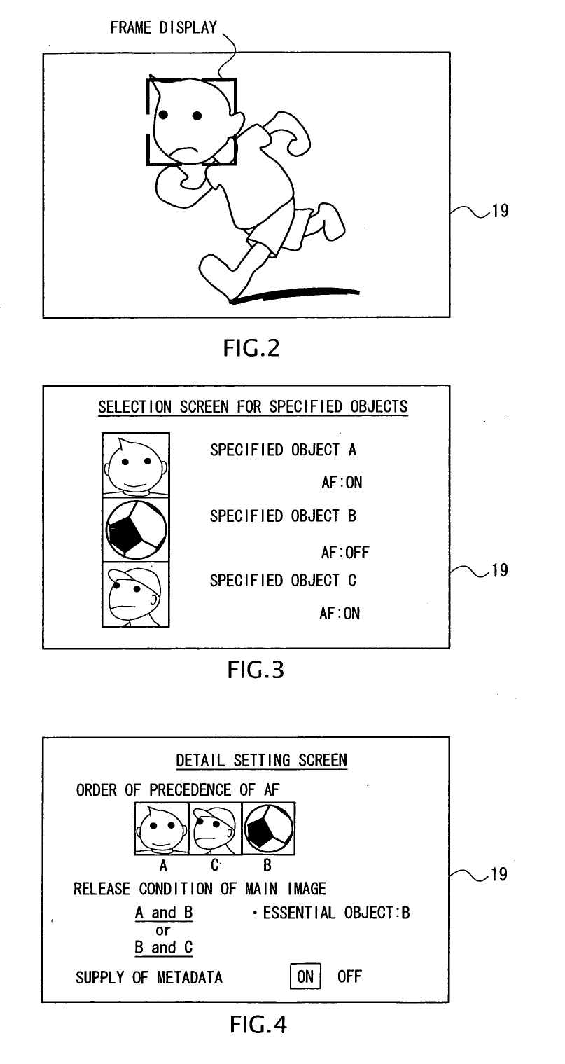

Further, as a second example, the CPU 23 generates, through similar steps as in the aforementioned first example, the feature information by setting the object inside the rectangular frame as the registered object after the decision button is pressed. Thereafter, the CPU 23 recognizes the registered object based on the generated feature information, and tracks the registered object in the moving image being reproduced to display it on the monitor 19. For example, the CPU 23 indicates the registered object that could be recognized on the monitor 19 by a frame display or the like (refer to FIG. 2). Subsequently, when detecting the press of the decision button again during the object recognition, the CPU 23 generates each piece of the feature information from each frame in which the object recognition could be realized in the moving image file.

<Setting of Object Recognition Mode>

Further, the user can change the setting of the electronic camera 10 regarding the object recognition mode on the menu screen. Concretely, it is possible to change, on the menu screen, a setting regarding (1) a selection of specified object, (2) a release condition of main image, (3) a supply of metadata, and the like. Note that display processing, control and the like on the menu screen are each executed by the CPU 23 based on a predetermined program.

Regarding an item of the aforementioned (1) selection of specified object, the user can specify the specified object to be a target of object recognition processing among the registered objects registered in the second memory 22. In the present embodiment, two or more of the registered objects can be simultaneously specified as the specified objects. Note that FIG. 3 shows an example of a selection screen for specified objects. Further, FIG. 4 shows a detail setting screen which can be transited from the screen of FIG. 3.

Further, the CPU 23 in the object recognition mode executes the AF by setting a position of the specified object as the focus detecting area. Accordingly, on the menu screen, the user can select the specified object and set ON/OFF of the AF with respect to each specified object and an order of precedence for setting the focus detecting area in a scene in which a plurality of specified objects exist (an order of precedence of AF with respect to the specified objects) (refer to FIG. 3 and FIG. 4). Note that in an initial state, the order of precedence of AF is set to be higher in accordance with the previous recording date and time of the feature information.

Regarding an item of the aforementioned (2) release condition of main image, the user can set (2a) a recognition state of specified object when automatic shooting is performed and (2b) a termination timing of automatic shooting, as conditions for performing the automatic shooting at the time of recognizing the specified object.

Regarding an item of the aforementioned (2a) recognition state of specified object, it is possible to set that the electronic camera 10 performs the automatic shooting when which specified object among the plurality of specified objects is recognized. Note that FIG. 4 shows a screen of setting example in performing the automatic shooting when a specified object A (person) and a specified object B (soccer ball) are recognized and when the specified object B and a specified object C (person) are recognized, in which the specified object B is set as an essential recognition target.

Further, regarding the item of (2a) recognition state of specified object, the user can also specify the positions of the specified objects so that the electronic camera 10 can perform the automatic shooting when the specified objects are in predetermined positions. Accordingly, a composition of the main image at the time of automatic shooting can be determined by the user.

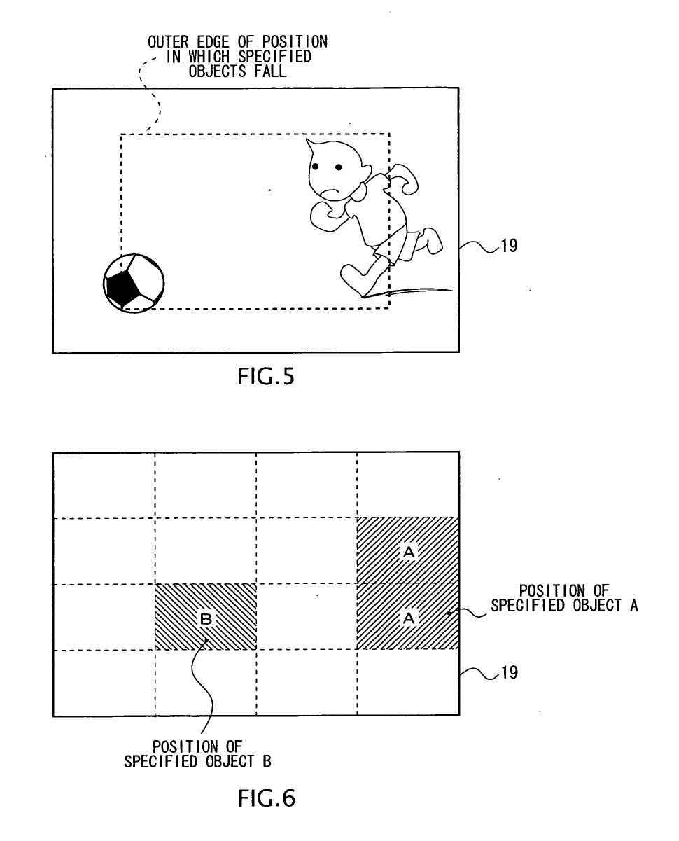

In this case, the user switches the menu screen to a screen in FIG. 5 or FIG. 6 and specifies the positions of the specified objects. For example, as shown in FIG. 5, the user can specify a range of the position in which the specified objects fall. Further, as shown in FIG. 6, the user can more specifically determine the positions of each of the specified objects at the time of automatic shooting by specifying the positions from small regions divided in a matrix form. Furthermore, if the specified objects move in a certain direction, it is also possible to previously specify a region in which the automatic shooting starts and a region in which the automatic shooting terminates when the specified objects are overlapped (illustration in this case will be omitted).

Regarding an item of (2b) termination timing of automatic shooting, the user can set either of the number of shooting frames, a continuous shooting time, a frame-out of the specified object and the user's operation (for instance, to press the release button 21 to terminate the shooting), for example, as termination conditions of the automatic shooting. It is of course possible that values of the aforementioned number of shooting frames and continuous shooting time can be freely set by the user.

Regarding the aforementioned (3) supply of metadata, the user can set whether or not to record the data of the main image shot in the automatic shooting by corresponding metadata regarding a main object thereto.

<Operation of Electronic Camera in Object Recognition Mode>

Next, a shooting operation in the object recognition mode will be described. Here, in the object recognition mode, the CPU 23 reduces an exposure time and opens an aperture by one stage, compared to the case of a normal program auto. Further, in the object recognition mode, the CPU 23 makes, if necessary, an imaging sensitivity higher than that in the normal program auto using means such as an addition and reading of pixels and a gain adjustment. Besides, a continuous shooting is basically performed in the object recognition mode, so that the CPU 23 prohibits a light emission of a flashlight emitting device (not shown).

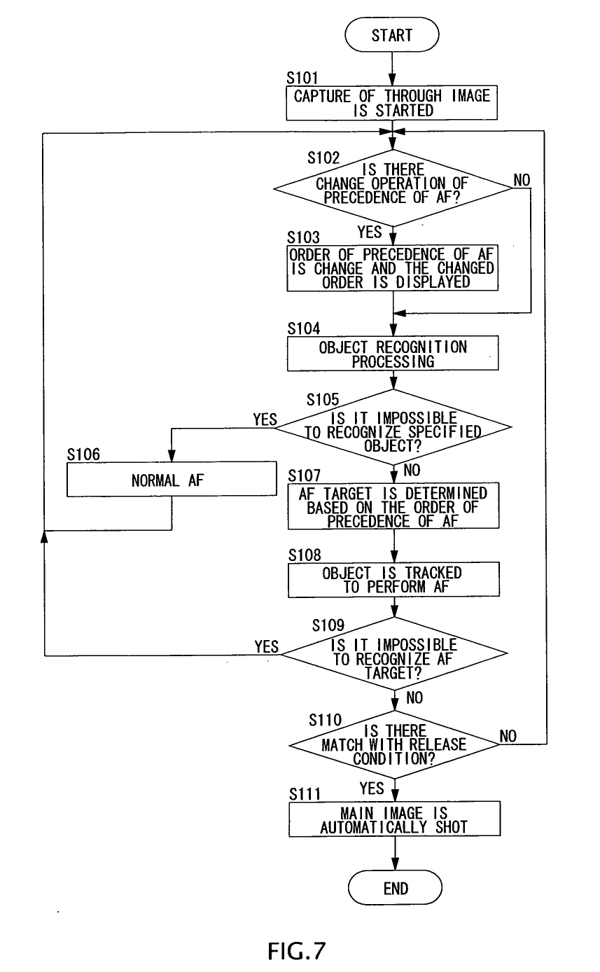

Hereinafter, the shooting operation in the object recognition mode will be more specifically described while referring to a flow chart of FIG. 7.

Step 101: The CPU 23 drives the image sensor 13 to start capturing the through image. Thereafter, the through image is sequentially generated by a predetermined interval. Further, the CPU 23 movie-displays the through image on the monitor 19. Consequently, it is possible for the user to perform a framing for determining a shooting composition by the through image on the monitor 19.

Step 102: The CPU 23 determines whether or not a change operation of the order of precedence of AF with respect to the specified objects is accepted from the user. When the above operation is performed (YES side), the CPU 23 proceeds to 5103. Otherwise, when the above operation is not performed (NO side), the CPU 23 proceeds to 5104.

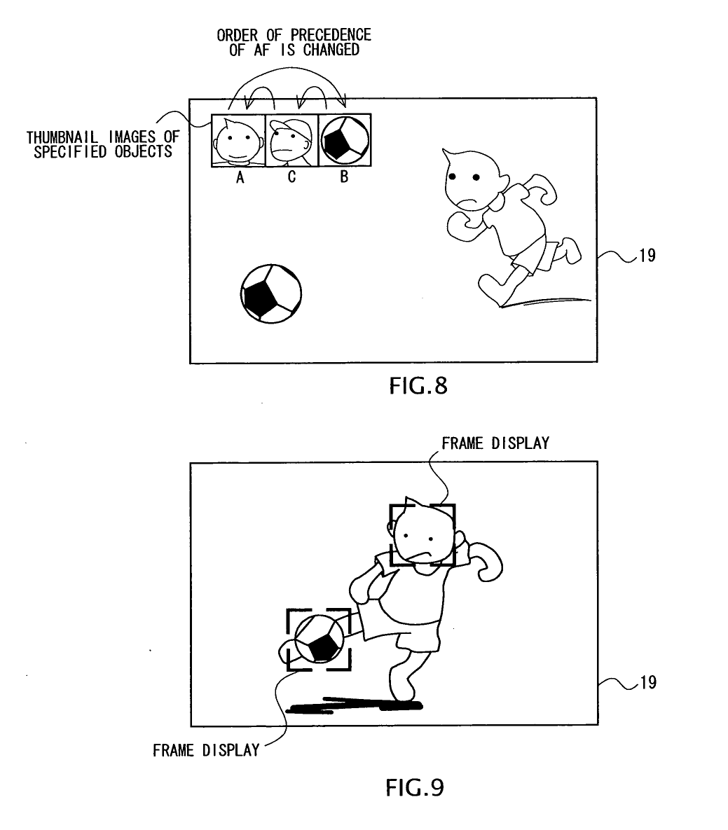

Step 103: the CPU 23 changes the order of precedence of AF with respect to the specified objects in accordance with the user's operation. Specifically, the CPU 23 changes the order of precedence of the specified objects for selecting the focus detecting area. As an example, FIG. 8 shows a change screen for the order of precedence of AF at the time of activating the object recognition mode.

When the user operates the command dial of the operation member 20, the CPU 23 displays the current order of precedence of AF with respect to the specified objects together with the thumbnail images of the respective specified objects on the through image in a superimposed manner. In the case of FIG. 8, the thumbnail images of the specified objects are shown in which they are lined up, from the left, in the order of the high order of precedence of AF. Subsequently, the CPU 23 changes the order of precedence of AF with respect to each of the specified objects in accordance with the rotation of the command dial. For example, in accordance with the rotation of the command dial, the CPU 23 sets the order of precedence of AF with respect to the specified object A, which is the highest, to be the lowest one, and respectively moves up the order of precedence of AF with respect to the other specified objects by one. Further, in conjunction with the change in the order of precedence of AF, the CPU 23 displays the thumbnail images on the monitor 19 by changing their lining order. Accordingly, the user can change the order of precedence of AF with respect to the specified objects with a simple operation. In addition, since the user can intuitively grasp the changed order of precedence of AF from the thumbnail images, there is no chance of causing confusion.

Step 104: The CPU 23 executes the object recognition based on the feature information on each of the specified objects, and searches the specified object from the through image.

Step 105: The CPU 23 determines whether or not the specified object cannot be recognized in the through image in 5104. When the specified object cannot be recognized (YES side), the CPU 23 proceeds to 5106. Otherwise, when the specified object can be recognized (NO side), the CPU 23 proceeds to 5107.

Step 106: The CPU 23 in this case executes the normal AF by following an algorithm of a center priority or a close priority. Thereafter, the CPU 23 returns to 5102 and repeats the above operation. Note that when the specified object cannot be recognized, the CPU 23 may return to 5102 without performing the AF.

Step 107: The CPU 23 sets, as an AF target, the specified object to which the highest order of precedence of AF is provided among the specified objects which can be recognized from the though image (S104).

Step 108: The CPU 23 continuously selects the corresponding position of the specified object being the AF target (S107) as the focus detecting area. Subsequently, the CPU 23 successively executes the AF based on the focus detecting area corresponding to the specified object. Specifically, in the present embodiment, when there exist the specified objects in the shooting screen, the CPU 23 automatically tracks the specified object to which the highest order of precedence of AF is provided, and performs the AF.

Step 109: The CPU 23 determines whether or not the specified object being the AF target (S107) cannot be recognized from the through image. When the above condition is met (YES side), the CPU 23 returns to 5102 and repeats the above operation. For instance, when the electronic camera 10 could recognize the plurality of specified objects in 5104, the CPU 23 selects again the specified object to be the AF target among the remaining specified objects. Otherwise, when the above condition is not met (NO side), the CPU 23 proceeds to 5110.

Step 110: The CPU 23 determines whether or not the current state of the through image matches the release condition of the main image (setting contents regarding the recognition state of the specified object) on the menu screen. When the above condition is met (YES side), the CPU 23 proceeds to S111. Note that an example of a state where the setting regarding the recognition state of the specified object and the through image match is schematically shown in FIG. 9. Otherwise, when the above condition is not met (NO side), the CPU 23 returns to 5102 and repeats the above operation.

Step 111: The CPU 23 drives the image sensor 13 to automatically capture the main image in accordance with the release condition of the main image set on the menu screen (the setting regarding the recognition state of the specified object and the setting regarding the termination timing of the automatic shooting).

Note that when the setting item regarding the supply of metadata is set as ON on the menu screen, the CPU 23 records the metadata regarding the main object by corresponding the data to the data of the main image. Here, the aforementioned metadata is recorded in the header region of the image file of the main image by using a MakerNote tag of the Exif standard.

Further, as contents of the metadata, information on the specified objects included in the main image (for example, a text regarding the attribute information registered in the second memory 22 and so on), and data regarding the positions of each of the specified objects in the main image are included. Accordingly, when the images in which the specified objects are shot are sorted to be searched, when portions in which the specified objects are shot are trimmed from the main image after the shooting or the like, the convenience to the user is further enhanced with the use of the aforementioned metadata. Thus, the explanation regarding FIG. 7 is completed.

Hereinafter, the operation and effect of the electronic camera of the first embodiment will be explained. The electronic camera of the first embodiment automatically executes the shooting of the main image when the plurality of specified objects specified by the user can be simultaneously recognized. Accordingly, it becomes possible to make the electronic camera automatically shoot a scene in which the plurality of main objects are simultaneously within the shooting screen, which enables to relatively easily obtain the main image whose composition is close to an image held by the user. In particular, it is also possible to make the electronic camera perform the automatic shooting by specifying the positions of the specified objects in the shooting screen in the first embodiment, so that in this case, a chance of obtaining the main image which perfectly matches the image held by the user is further increased.

Further, in the first embodiment, it is possible to generate the feature information on the registered object based on the recording image and the through image captured by the electronic camera or the recording image read from the outside. Therefore, the registration of the object can be realized using various sources, which largely increases the convenience to the user in using the object recognition function of the electronic camera.

Further, in the electronic camera of the first embodiment, it is possible to perform the AF by tracking the main specified object, which reduces the chance of the shooting failure in which the specified objects are out of focus. In particular, since the order of precedence of AF with respect to the specified objects can be changed by the user's operation in the first embodiment, it becomes easy to appropriately conduct the AF in accordance with the change in the state of the scenes, and the convenience to the user is also enhanced in that respect.

### Explanation of Second Embodiment

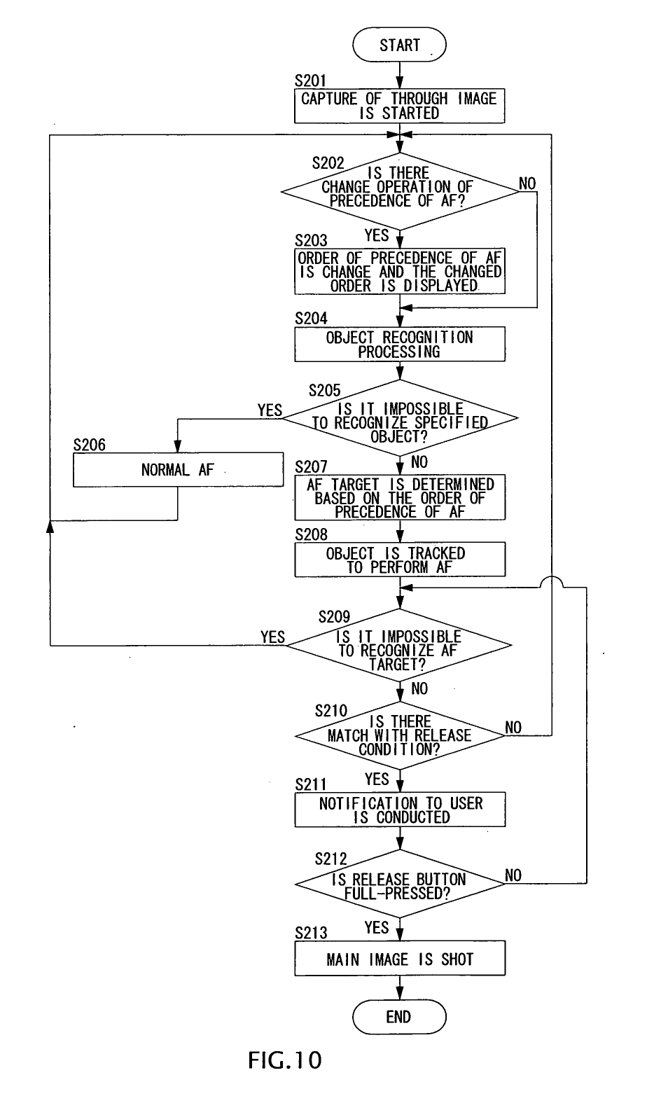

FIG. 10 is a flow chart showing a shooting operation in an object recognition mode in an electronic camera of a second embodiment. Here, the second embodiment is a modified example of the aforementioned first embodiment, in which the electronic camera displays a warning on the monitor 19 when a condition of recognition state of specified objects set on a menu screen is satisfied.

Further, a configuration of the electronic camera of the second embodiment is common with the electronic camera of the first embodiment shown in FIG. 1, and therefore, the duplicating explanation will be omitted. Note that 5201 to 5209 in FIG. 10 respectively correspond to 5101 to 5109 in FIG. 7, and therefore, the duplicating explanation will be omitted.

Step 210: The CPU 23 determines whether or not the current state of the through image matches the setting contents regarding the recognition state of the specified objects on the menu screen. When the above condition is met (YES side), the CPU 23 proceeds to 5211. Otherwise, when the above condition is not met (NO side), the CPU 23 returns to 5202 and repeats the above operation.

Step 211: The CPU 23 outputs a notification to the user indicating that the recognition states of the specified objects set by the user are realized. For instance, the CPU 23 displays a message or a character indicating that all the specified objects are appeared on the monitor 19. Alternatively, the CPU 23 may change the color of the frame display indicating the specified objects on the monitor 19. Further, the CPU 23 may output a voice alarm to a not-shown speaker.

Step 212: The CPU 23 determines whether or not the release button 21 is full-pressed by the user. When the release button 21 is full-pressed (YES side), the CPU 23 proceeds to 5213. Otherwise, when the release button 21 is not full-pressed (NO side), the CPU 23 returns to 5209 and repeats the above operation.

Step 213: The CPU 23 drives the image sensor 13 to capture the main image. Note that when the setting item regarding the supply of metadata is set as ON on the menu screen, the CPU 23 records the metadata regarding the main object by corresponding the data to the data of the main image. Note that explanation for the metadata is in common with 5111 of FIG. 1, and hence the duplicating explanation will be omitted. Thus, the explanation regarding FIG. 10 is completed.

The electronic camera of the second embodiment executes the notification to the user when the plurality of specified objects specified by the user can be simultaneously recognized. Accordingly, it becomes possible that the user can easily grasp a photo opportunity, which enables to relatively easily obtain the main image whose composition is close to an image held by the user.

### Explanation of Third Embodiment

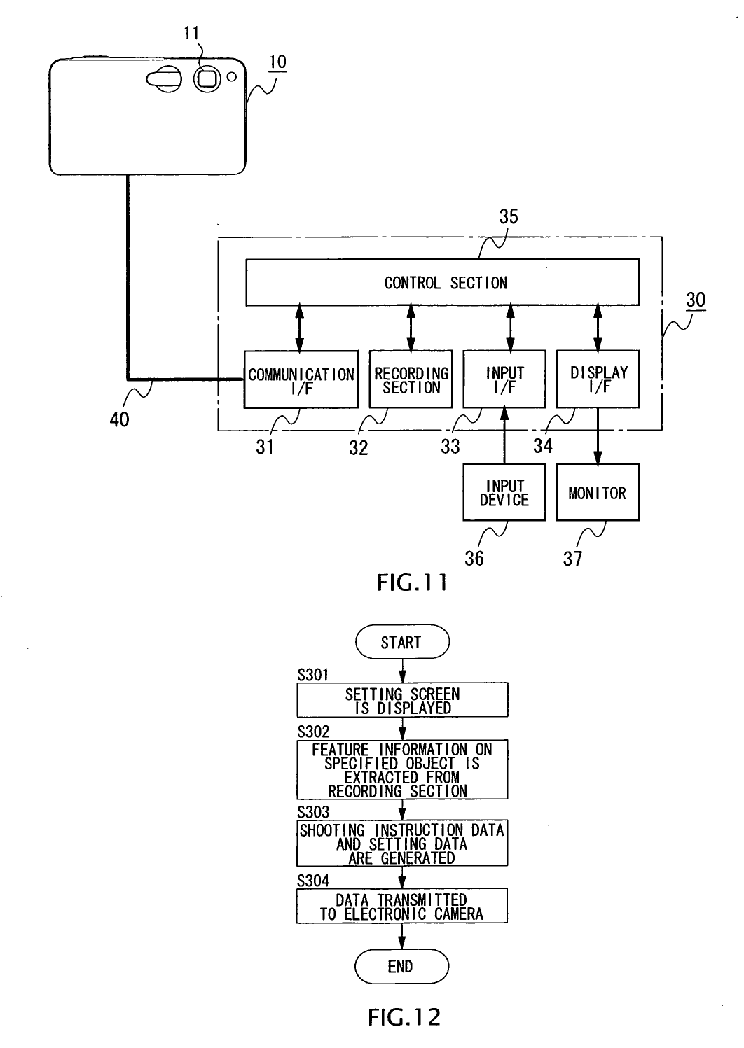

FIG. 11 is a view schematically showing a configuration of an electronic camera system of a third embodiment. The third embodiment takes a configuration in which a computer executes a setting regarding shooting of an electronic camera before the electronic camera executes the automatic shooting.

The above-described electronic camera system has an electronic camera 10 and a computer 30. The electronic camera 10 and the computer 30 are mutually coupled by a wire or wireless well-known communication line 40. Note that the electronic camera 10 of the third embodiment is common with the one in the first embodiment, and hence the explanation thereof will be omitted.

Meanwhile, the computer 30 has a communication I/F 31, a recording section 32, an input I/F 33, a display I/F 34 and a control section 35. Here, each of the communication I/F 31, the recording section 32, the input I/F 33 and the display I/F 34 is coupled to the control section 35. Further, an external input device 36 (a keyboard, a pointing device or the like) is coupled to the input I/F 33. In addition, a monitor 37 is coupled to the display I/F 34.

The communication I/F 31 controls transmission/reception of data to/from the electronic camera 10 being a coupling destination in compliance with a communication standard of the communication line 40. In the recording section 32, pieces of feature information corresponding to a plurality of registered objects are accumulated. The input I/F 33 accepts various kinds of inputs from the user via the input device 36. The display I/F 34 outputs images to the monitor 37. Further, by the execution of a program, the control section 35 executes processing regarding the change in the setting relating to the object recognition mode of the electronic camera 10.

Hereinafter, an operation of the computer in the third embodiment will be explained while referring to a flow chart of FIG. 12.

Step 301: The control section 35 displays a setting screen for conducting the change in the setting of the electronic camera 10 on the monitor 37. Subsequently, the control section 35 performs a display which prompts the user to select two or more of specified objects among the registered objects registered in the recording section 32. Note that on the above-described setting screen, the user can also perform a setting regarding the release condition of main image and the supply of metadata via the input device 36 (explanation regarding the release condition of main image and the supply of metadata is in common with the first embodiment, and hence the duplicating explanation will be omitted).

Step 302: Upon receiving the selection input of the two or more of the specified objects from the user, the control section 35 extracts the feature information corresponding to each of the specified objects from the recording section 32.

Step 303: The control section 35 generates shooting instruction data which instructs the electronic camera 10 to perform the automatic shooting and setting data such as the release condition of main image.

Step 304: The control section 35 transmits the feature information corresponding to each of the specified objects (S302), and the shooting instruction data and the setting data (S303) to the electronic camera 10.

Note that upon receiving the respective pieces of the above data, the electronic camera 10 is activated in the object recognition mode. Subsequently, the electronic camera 10 recognizes the specified objects in a manner as in the flow chart of FIG. 7 of the first embodiment, and further, it executes the automatic shooting of the specified objects in accordance with the condition regarding the setting data (S303). Thus, the explanation of FIG. 12 is completed.

According to the third embodiment, it is possible to reduce the burden of setting operation for the user when remote-controlling the electronic camera 10 of the first embodiment. The effect becomes significant especially when a plurality of the electronic cameras 10 of the first embodiment which are remote-controlled are applied.

(Supplementary Items to the Embodiment)

(1) In the aforementioned embodiment, the feature information is not limited to the image of the registered object, and may be data indicating parameters such as, for instance, an edge component, a brightness, a color difference and a contrast ratio of the image shot. Further, when the registered object is a face of a person, a position of a feature point of the face, a relative distance among each of the feature points and the like can also be set as the feature information.

(2) In the first embodiment, an example in which the feature information is generated in the electronic camera 10 based on the recording image is explained, but, it is also possible that, for example, the previously processed feature information on the registered object is downloaded via the communication I/F 18 and the CPU 23 records it in the second memory 22.

(3) Regarding the thumbnail image of the first embodiment, if it is a face of a person, an image of a facing front is preferable, and if it is the through image or the moving image, an image specified by the user is preferable. Note that when the thumbnail image and the image of the feature information are used in common, it is preferable to attach an identifier such as a marker to the feature information which is used in common with the thumbnail image.

(4) In the first embodiment, an example in which the still image is shot in accordance with the result of object the recognition is explained, but, the configuration of the electronic camera of the present application can also be applied to the case of shooting the moving image. Note that at the time of shooting the moving image, it becomes possible to track the specified object and conduct the AF based on the result of the object recognition, and to supply metadata, to the moving image data, indicating a time zone in which the specified object being the recognition target is shot.

Note that the present application can be embodied in other various forms without departing from the spirit or essential characteristics thereof. The above embodiments are therefore to be considered in all respects as illustrative and not restrictive. The present application is indicated by the scope of appended claims, and in no way limited by the text of the specification. Moreover, all modifications and changes that fall within the equivalent scope of the appended claims are deemed to be within the scope of the present application.

1. An imaging apparatus, comprising:
an imaging section capturing an image of an object and generating data of the image;
a memory recording pieces of feature information respectively corresponding to each of a plurality of registered objects to be recognized as recognition targets; and
a control section recognizing the registered objects included in the image based on the feature information and executing predetermined processing when two or more of specified objects which are specified among the registered objects are included in the image.

2. The imaging apparatus according to claim 1, wherein
the control section executes at least one of processings among a first processing instructing the imaging section to capture a recording image, a second processing outputting a notification to a user, and a third processing generating metadata regarding the specified objects.

3. The imaging apparatus according to claim 2, wherein
the control section instructs to capture the recording image when at least one of the specified objects is in a predetermined position in the image at the time of executing the first processing.

4. The imaging apparatus according to claim 1, wherein
the control section generates the feature information from one among three types of data, the three types of data being data of a first recording image captured by the imaging section, data of a second recording image read from the outside, and data of a through image captured by the imaging section when unrecorded.

5. The imaging apparatus according to claim 1, further comprising:
a focus detecting section detecting a focus state in a focus detecting area set in a shooting screen;
a focus detecting area selecting section continuously selecting a corresponding position of the specified objects in the shooting screen as the focus detecting area based on a result of the recognition;
an operation section accepting an operation from a user; and
a tracking setting section changing an order of precedence of the specified objects, in accordance with the operation, for selecting the focus detecting area in a scene where a plurality of the specified objects exist.

6. The imaging apparatus according to claim 1, further comprising
an operation section accepting an operation from a user, wherein
the control section sets the specified objects among the registered objects based on the operation.

7. A computer-readable storage medium storing a program executable by a computer configured to be able to communicate with an imaging apparatus including
an imaging section capturing an image of an object and generating data of the image,
a memory capable of recording pieces of feature information respectively corresponding to each of a plurality of registered objects to be recognized as recognition targets,
a camera control section recognizing the registered objects included in the image based on the feature information and automatically executing a capture of recording image when two or more specified objects which are specified among the registered objects are included in the image, and
a camera communication section, the computer comprising
a communication section transmitting data to the imaging apparatus,
a recording section accumulating the pieces of feature information corresponding to the plurality of the registered objects, and
a calculation processing section, where in
the program causes the calculation processing section to execute:
a first step accepting an input from a user to select two or more of the specified objects among the registered objects and extracting the pieces of feature information respectively corresponding to each of two or more of the specified objects from the recording section; and
a second step transmitting the feature information extracted in the first step to the imaging apparatus.
